(19) United States
(12) Patent Application Publication
(10) Pub. No.: US 2012/0084038 A1
(43) Pub. Date: Apr. 5, 2012

(54) AUTONOMOUS DISTRIBUTED THERMOCOUPLE CONTROL

(75) Inventors: Francisco P. Maturana, Mayfield Heights, OH (US); Raymond J. Staron, Chagrin Falls, OH (US); Danny L. Carnahan, Hudson, OH (US)

(73) Assignee: ROCKWELL AUTOMATION TECHNOLOGIES, INC., Mayfield Heights, OH (US)

(21) Appl. No.: 12/895,008

(22) Filed: Sep. 30, 2010

(51) Int. Cl. G06F 19/00; G01K 15/00

(52) U.S. Cl. 702/99; 374/1

(57) ABSTRACT

Aspects describe creation of autonomous control for a composite curing process. Other aspects describe a controller and an apparatus for employing an autonomous control algorithm for a composite curing application. The algorithm can be based on thermocouple rules encapsulated within a thermocouple control wrapper. The thermocouple rules allow the thermocouple wrapper carry out diagnostic operations to determine the health of the associated thermocouple by communicating with neighboring thermocouples and validating temperature readings according to the thermocouple rules.

### TECHNICAL FIELD

The subject disclosure relates to an autoclave utilized in composite curing processes and to an apparatus associated with the autoclave that can reconfigure a control loop associated with the autoclave according to autonomous control.

### BACKGROUND

Composite curing can be accomplished through proper application of heating and cooling to composite material inside autoclaves or automated ovens. Composite materials are cured under very stringent specifications. For example, specifications (e.g., control recipes and/or profiles) can relate to temperature, pressure and/or vacuum conditions. Generally, temperature specifications are the most important. Millions of dollars of composite materials could be lost during one imperfect curing process run: if composites are cured at a temperature that is too high, the material could become brittle and will be susceptible to breaking; on the other hand, if composites are cured at a temperature that is too low, the material may not bond correctly and will eventually come apart. However, the temperature specifications are generally difficult to control.

Classical control methods are utilized to monitor and control temperature within the autoclave. Thermocouples are attached to the composite material in a scattered pattern to monitor temperature within the autoclave. A leading thermocouple is selected and its temperature reading is fed back to a controller. Any malfunction of the leading thermocouple can lead to erroneous data being fed to the controller.

Although the curing process is performed in a controlled environment, there are dynamic perturbations affecting the thermocouples that could generate unsatisfactory results, and provoke a complete rejection of an expensive piece of composite material. For example, one perturbation could include a potential malfunctioning of a thermocouple itself. A malfunctioning thermocouple can appear healthy upon visual inspection, but its internal operations may generate inaccurate readings. Problems of this type are difficult to detect offline, so they often go undetected until the curing process has undergone several steps. Classical control programs residing in a controller do not possess the intelligence to early detect such problems.

Another type of problem can occur when a thermocouple detaches from the material during curing. The autoclave is a sealed controlled environment that cannot be interrupted to reattach the thermocouple. The controller is also generally unable to react to the failing thermocouple by performing corrective actions on the fly without disrupting the operation of the autoclave.

A viable solution to these problems can be to augment the intelligence and/or reasoning capability of the control system with more sophisticated reasoning algorithms. Such algorithms can follow the process to generate a model from it. Monitoring rules can be added to detect malfunctioning sensors. Typically, a PC work station is added to supervise the control system. This approach converts the solution into a centralized system, but the centralized system suffers from other problems, such as a single point of failure and connectivity issues, which exacerbate the problem of maintaining a robust system for the whole duration of the process.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect is a method for configuring a composite curing process. The method comprises associating at least one thermocouple wrapper with at least one thermocouple from a plurality of thermocouples scattered on the surface of a composite material being cured in an autoclave. The method further comprises determining that the at least one thermocouple is a leading thermocouple based at least in part on a business rule and changing an assignment of the at least one thermocouple wrapper associated with the at least one thermocouple to lead. The method further comprises validating a temperature reading of the at least one thermocouple according to a thermocouple rule encapsulated within the thermocouple wrapper. The thermocouple rule can be, for example, that the reading should fall within a uniform distribution when compared to neighboring thermocouple readings.

According to an aspect is an industrial controller that controls a composite curing process. The industrial controller comprises a memory configured to store at least one thermocouple wrapper that encapsulates at least one thermocouple and at least one thermocouple rule. The industrial controller further comprises an interface configured to store at least one business rule for setting a leading thermocouple. The industrial controller further comprises a processor configured set the at least one thermocouple as the leading thermocouple based at least in part on the business rule and execute the at least one thermocouple wrapper to validate readings from the at least one thermocouple according to the at least one thermocouple rule. The thermocouple rule can be, for example, that the reading should fall within a uniform distribution when compared to neighboring thermocouple readings.

According to an aspect is an apparatus that controls a composite curing process. The apparatus comprises a memory configured to store at least one thermocouple wrapper that encapsulates at least one thermocouple and at least one thermocouple rule. The apparatus further comprises an interface configured to store at least one business rule for setting a leading thermocouple. The apparatus further comprises a processor configured set the at least one thermocouple as the leading thermocouple based at least in part on the business rule and execute the at least one thermocouple wrapper to validate readings from the at least one thermocouple according to the at least one thermocouple rule. The thermocouple rule can be, for example, that the reading should fall within a uniform distribution when compared to neighboring thermocouple readings.

To the accomplishment of the foregoing and related ends, one or more aspects comprise features hereinafter fully described. The following description and annexed drawings set forth in detail certain illustrative features of one or more aspects. These features are indicative, however, of but a few of various ways in which principles of various aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

FIG. 1 is a block diagram representation of an exemplary industrial control system.

FIG. 2 is a block diagram representation of an exemplary industrial control system for a composite curing process.

FIG. 3 is a block diagram representation of an aspect of an automated control algorithm executed by a controller.

FIG. 4 is a block diagram representation of an aspect of an automated control algorithm executed by a controller.

FIG. 5 is a block diagram representation of an aspect of an automated control algorithm for a composite curing process executed by a controller.

FIG. 6 is a process flow diagram of automatic reconfiguration of a composite curing process.

FIG. 7 is a process flow diagram of an aspect of an automated control algorithm for a composite curing process.

FIG. 8 is a process flow diagram of an aspect of an automated control algorithm for a composite curing process.

FIG. 9 is a process flow diagram of automatic reconfiguration of a composite curing process.

FIG. 10 is a block diagram of a computer operable to execute the disclosed aspects.

FIG. 11s is a schematic block diagram of an exemplary computing environment, according to an aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing these aspects.

As used in this application, the terms “component,” “module,” “agent”, “wrapper,” “algorithm,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

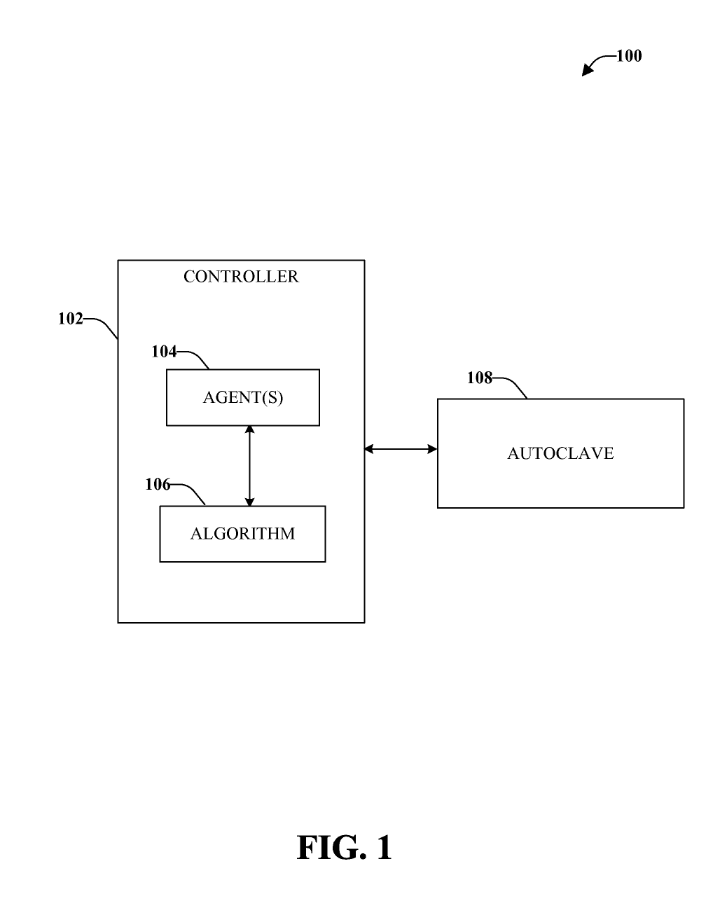

Referring initially to FIG. 1, illustrated is a block diagram illustration of an exemplary industrial control system 100, according to an aspect. According to an embodiment, the industrial control system 100 can be configured to control a composite curing process. Although the industrial control system 100 will be described herein as applied to a composite curing process, this is not meant to be limiting. A person having ordinary skill in the art will understand that the industrial control system 100 can control any number of industrial processes.

The industrial control system 100 can include a controller 102 that can be configured with advanced reasoning capabilities. For example, the controller 102 can be a programmable automation controller (PAC) and/or a programmable logic controller (PLC). The term “controller” as utilized herein can include functionality that can be shared across multiple components or networks. Additionally, a controller could be a hardware controller or a software controller.

According to an embodiment, the advanced reasoning capabilities can be provided to the controller 102 through agents 104. For example, agents 104 can be software components configured to encapsulate physical equipment knowledge and/or rules and/or properties in the form of capabilities. Capabilities can express the type of functions the agents 104 contribute to the well being of the system 100. Each capability can be a construct of behaviors. Each behavior can comprise sequentially organized procedures. Agents 104 can be integrated with a control algorithm 106 utilized by the controller 102.

The controller 102 can be configured to control at least one feature of a composite curing process. The composite curing process can be conducted in one or more autoclaves 108 or automated ovens. The controller 102 can be configured to communicate with the one or more autoclaves 108 across a network. The network can be a public network (e.g., the Internet) or a private network (e.g., Control and Information Protocol (CIP)).

According to an aspect, the algorithm 106 can be an autonomous control program that controls temperature within the autoclave 108. The algorithm 106 can be written in any language supported by the controller 102; for example, ladder logic, function chart, script, JAVA, C code, and so on.

According to an aspect, the controller 102 can include a memory (not shown) and one or more processor(s). The algorithm 106 and the agent(s) 104 can be stored in the memory and executed by the one or more processors.

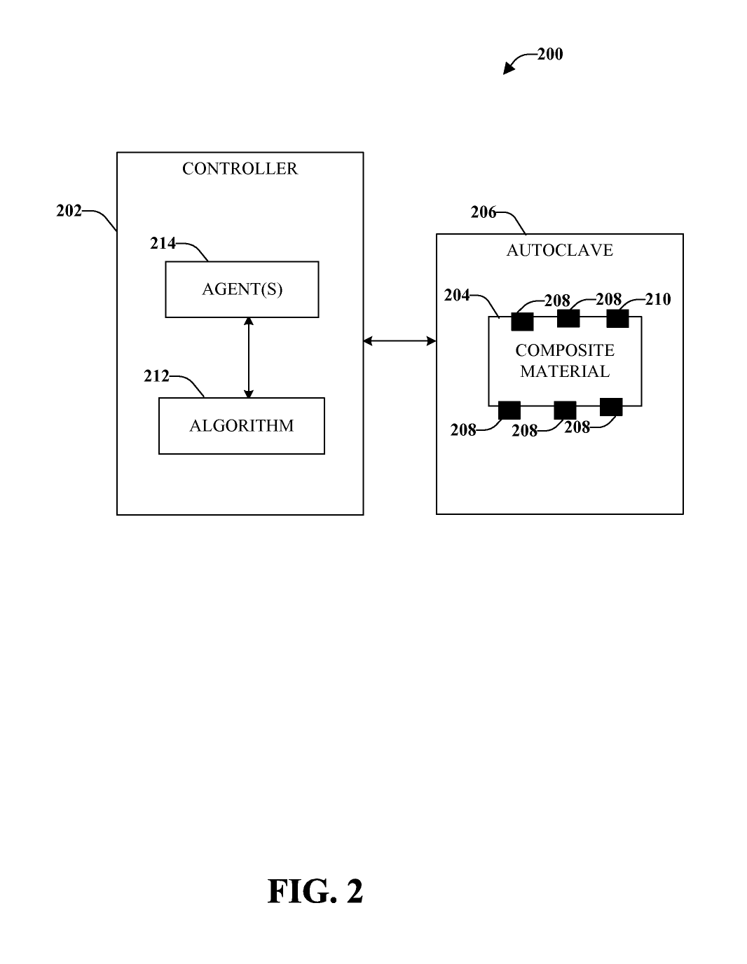

FIG. 2 is a block diagram illustration of an exemplary industrial control system 200 utilized in a composite curing process. The composite curing process can employ a controller 202 that can be configured to control the heating and cooling of a composite material 204 located inside an autoclave 206. Although a single composite material 204 is described herein, a person of ordinary skill in the art will understand that the autoclave 206 can heat and cool a plurality of composite materials 204 at a time. The plurality of composite materials 204 can include composite materials 204 of any number of shapes and sizes.

Thermocouples 208 can be attached to the composite material 204 scattered in different locations on the composite material 204. According to an aspect, the thermocouples 208 can be directly attached to the composite material 204. The thermocouples 208 can sense the ambient temperature of the autoclave 206 and feed temperature readings back to the controller 202. The controller 202 can be configured to employ a control loop, which can be driven, for example, by a proportional-integral-derivative (PID) loop. A leading thermocouple 210 can be selected from the thermocouples 208 to provide a representative ambient temperature of the autoclave 206 during the composite curing process to the controller 202. The controller 202 can be configured to utilize the temperature from the leading thermocouple in the control loop (e.g., the PID loop). Process control using the control loop depends on proper selection of the leading thermocouple 210. For example, the leading thermocouple 210 should provide an accurate representation of the ambient temperature within the autoclave 206. The leading thermocouple 210 can be selected, for example, according to a business rule.

Throughout the curing process, the leading thermocouples 210 can be damaged and rendered unusable. For example, the leading thermocouple 210 is exposed to high temperatures during the curing process, which may damage the leading thermocouple. In another example, the leading thermocouple 210 can become detached from the composite material. When the leading thermocouple 210 is rendered unusable, it is difficult to automatically reconfigure the system. Generally, when the leading thermocouple 210 is damaged, it continues to emit its signal to the controller 202, but the signal misleads the controller 202 into erroneous adjustments of the control loop. The leading thermocouple 210 can only be changed through human intervention.

According to an embodiment, the controller 202 can be configured with an autonomous control algorithm 212 that can automatically reconfigure the system when the leading thermocouple 210 is rendered unusable. The algorithm 212 can be written in any control language supported by the controller 202; for example, ladder logic, function chart, script, JAVA, C code, and so on.

The algorithm 212 can be coupled with one or more intelligent agents 214. The intelligent agents 214 eliminate the need for human intervention in reconfiguring the control loop and/or selecting a new leading thermocouple 210. According to an embodiment, the leading thermocouple 210 can be initially selected, for example, according to a business rule. The leading thermocouple 210 can send temperature readings during the curing process to the controller 202. The intelligent agents 214 can examine the temperature readings to determine whether the temperature reading is still accurate, indicating that the leading thermocouple 210 is undamaged. If the intelligent agents 214 determine that the leading thermocouple 210 is damaged and the temperature reading is no longer accurate, the algorithm 212 can select a new leading thermocouple 210 from the thermocouples 208. The new leading thermocouple 210 can send temperature readings during the curing process to the controller 202, and the intelligent agents 214 can monitor the temperature readings to determine whether the temperature reading is still accurate. The loop can repeat if the agents 214 determine that the new leading thermocouple 210 is no longer producing accurate temperature readings.

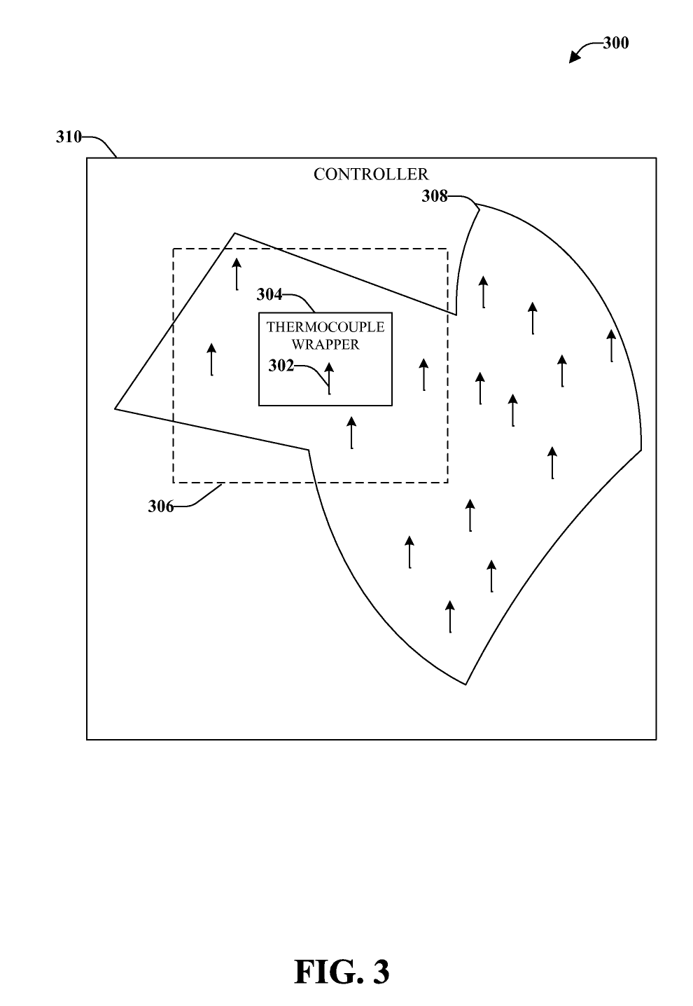

FIG. 3 is a block diagram representation of an aspect of an algorithm 300 for automated validation of health of a leading thermocouple 302. The leading thermocouple can be modeled by a thermocouple wrapper 304. The thermocouple wrapper 304 can encapsulate thermocouple rules to allow for validation of temperature readings from the leading thermocouple 302. For example, a thermocouple rule can be that the temperature readings from the leading thermocouple 302 and neighboring thermocouples 306 should be uniform within a predefined tolerance level.

Based on the thermocouple rules, the thermocouple wrapper 304 can carry out diagnostics operations to locally determine the health of the leading thermocouple 302. The thermocouple wrapper 306 is intended for low-level distributed control. According to an embodiment, the thermocouple wrapper 304 can be an intelligent agent that encapsulates the leading thermocouple 302. However, the algorithm 300 is not limited to agent encapsulation. For example, the thermocouple wrapper 304 can be programmed in structured text and utilize user-defined data structures to retain thermocouple status information and curing geometry configuration 308.

The leading thermocouple 302 can be grouped with neighboring thermocouples 306. Neighboring thermocouples 306 can be determined, for example, based at least in part on curing geometry 308. According to an aspect, the neighboring thermocouples can be further determined based in part on composite material and/or thermocouple density. A person of ordinary skill in the art will understand that the neighboring thermocouples 306 can each be encapsulated by individual thermocouple wrappers (not illustrated).

According to an aspect, the thermocouple wrapper 304 can communicate with neighboring thermocouples 306 within the same thermocouple group via message instruction communication. The neighboring thermocouples 306 can be located within the same controller 310 as the thermocouple wrapper 304 or can be located within a controller remote from the controller 310 (not shown).

The thermocouple wrapper 304 can exchange health information about the leading thermocouple 302 and the neighboring thermocouples 306, and determine whether the leading thermocouple 302 is still operational. For example, the thermocouple wrapper 304 can utilize the thermocouple rule to determine if the leading thermocouple 302 is still operational. If the thermocouple rule establishes that the temperature readings from the leading thermocouple 302 and the neighboring thermocouples 306 should be uniform, and the temperature reading from the leading thermocouple 302 is not uniform with the neighboring thermocouples 306, the thermocouple wrapper 304 can determine that the leading thermocouple 302 is no longer operational.

According to an aspect, the thermocouple wrapper 304 can receive health information from the neighboring thermocouples 306 and conduct an extrapolation and/or an interpolation of the health information about the neighboring thermocouples 306 to assess a health condition of the leading thermocouple 302. For example, the assessment can be based upon a statistical determination that the temperature reading from the leading thermocouple 302 is within the tolerance level for a uniform temperature distribution. If it is determined that the temperature reading from the leading thermocouple 302 falls outside the threshold (e.g. a three sigma threshold), readings can be taken and used to determine the health status of the leading thermocouple 302 is checked more frequently.

If the thermocouple wrapper 304 determines that the leading thermocouple 302 is not operational in light of the assessment, the algorithm 300 can trigger an autonomous selection of a new leading thermocouple from the neighboring thermocouples 306. The thermocouple wrapper 304 sets its status to indicate that the former leading thermocouple 302 should not be considered in any further calculations. A most stable thermocouple can be selected from the neighboring thermocouples 306 and a new group of neighboring thermocouples can be defined. A uniformly distributed temperature range can be determined, and a threshold (e.g., a three sigma threshold) can be calculated. The algorithm can repeat for each new leading thermocouple.

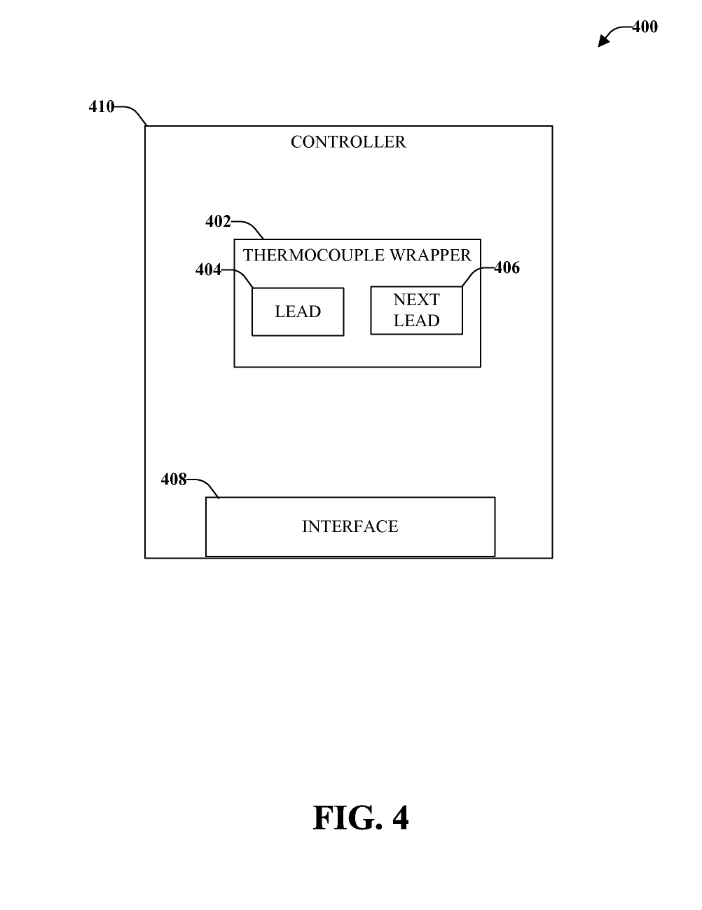

FIG. 4 is a block diagram representation of an aspect of an algorithm 400 for automated configuration of a thermocouple wrapper 402. The thermocouple wrapper 402 can be programmed with two assignments: thermocouple is a lead 404 or thermocouple is a next lead 406. The assignment can be chosen based on one or more business rules for the curing control process. The business rules can be, for example, user defined data structures encapsulated within an interface 408 that is understood and accessible by the thermocouple wrapper 402. According to an embodiment, the interface 408 can be local to a controller 410 that stores the thermocouple wrapper 402. According to another embodiment, the interface 406 can be remote from the controller 410.

According to an aspect, a user can define an initial leading thermocouple for the control process. This definition can be made, for example, according to a business rule. The thermocouple wrapper 402 can be assigned as the lead 404. A second thermocouple associated with another thermocouple wrapper can be assigned as the next lead 406. This assignment can be made according to a business rule. If the lead thermocouple fails to communicate with other thermocouples, or if the lead generates temperature readings outside a predefined threshold, the next thermocouple wrapper can assume the lead. The assignment in the thermocouple wrapper can change from next lead 406 to lead 404. The next thermocouple wrapper can notify the controller 410 of the change of the lead thermocouple.

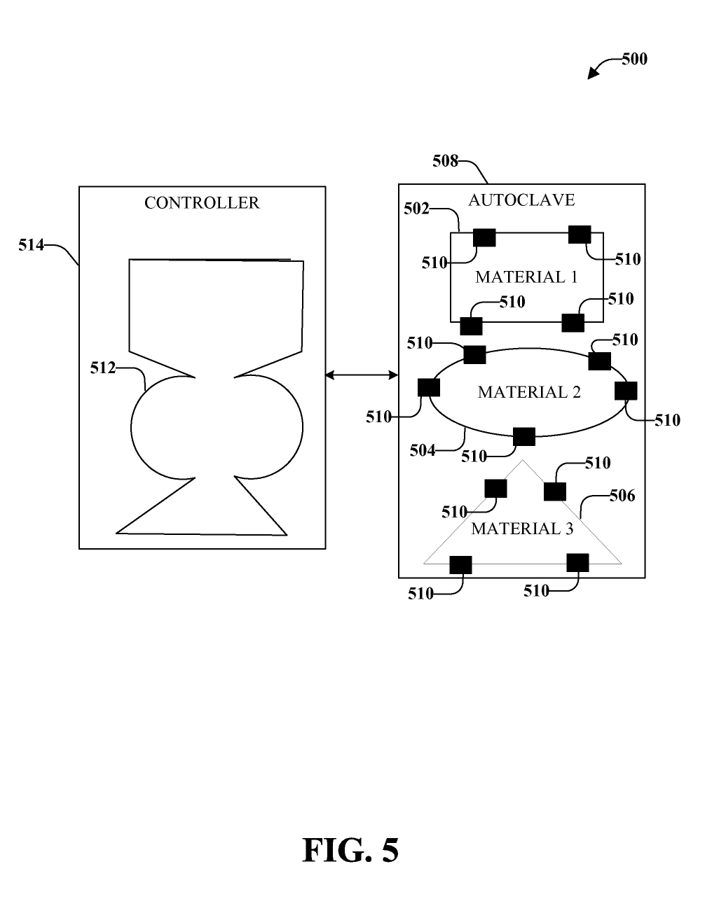

FIG. 5 is a block diagram representation of an aspect of an algorithm 500 for automated configuration of a composite curing process. As described above, during a composite curing process, multiple composite materials of different geometries 502-506 can be cured in an autoclave 508 at the same time. Thermocouples 510 can be scattered around the multiple pieces and attached to the multiple pieces 502-506. As illustrated, the thermocouples 510 are merely a representation of but one distribution across the surfaces of the multiple pieces 502-506. A person having ordinary skill in the art would understand that any number of thermocouples 510 can be scattered around the surfaces of the multiple pieces 502-506 in any conceivable manner.

Due at least in part to the physical separation between the multiple pieces 502-506 inside the autoclave 508, discontinuities exist when trying to configure a group of neighboring thermocouples, for example, as described with respect to FIG. 3. The physical separation brings the need to calculate a dispersion factor with regard to temperature readings from the thermocouples 510.

Groups of thermocouples 510 can form from several thermocouples 510 either one the same piece or on different pieces 502-506. Each group of thermocouples 510 has a leading thermocouple selected, for example, according to a business rule. The leading thermocouple from each group can talk to other leading thermocouples from other groups to establish a virtual representation of the composite parts to establish a virtual cured part 512 that serves as a guide for extrapolating a temperature trend. After the virtual cured part 512 is calculated, a representative thermocouple for the overall process can be selected to feed temperature data to the controller 514 of the curing process. If the representative thermocouple is found to be unresponsive or incorrect, the thermocouple can be deactivated, and the process can repeat until another representative thermocouple can be selected.

In view of exemplary systems shown and described above, methodologies that may be implemented in accordance with the disclosed subject matter, will be better appreciated with reference to various flow charts. While, for purposes of simplicity of explanation, methodologies are shown and described as a series of blocks, it is to be understood and appreciated that the various embodiments described herein are not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g. device, system, process, component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

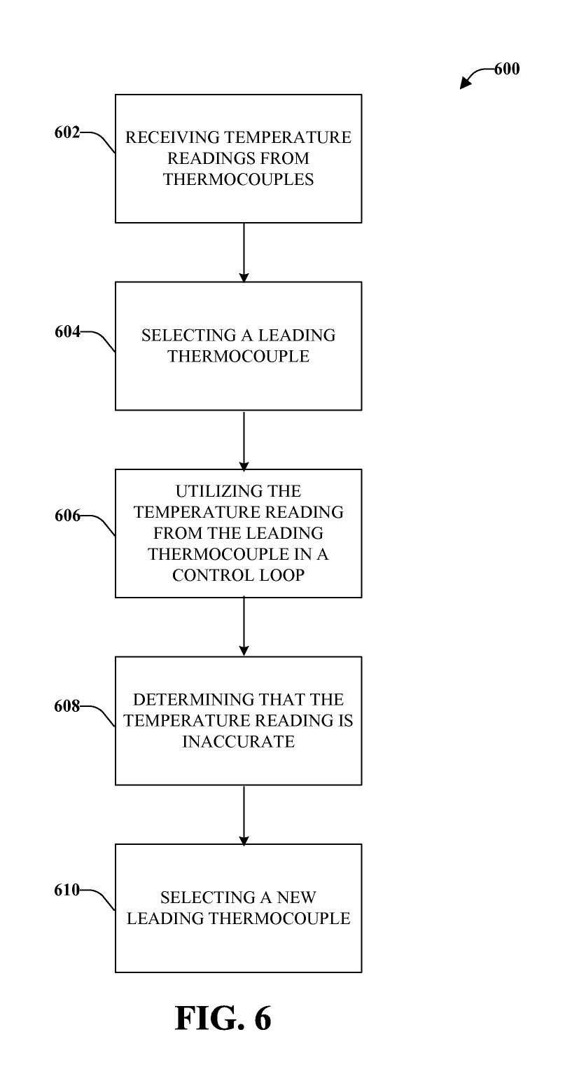

FIG. 6 is a process flow diagram 600 for automatic reconfiguration of a composite curing process. At 602, a controller can receive temperature readings from one or more thermocouples attached to a composite material, scattered in different locations on the material. The material can be located inside an autoclave to undergo the curing process. Although a single composite material is described herein, a person of ordinary skill in the art will understand that the autoclave can heat and cool a plurality of composite materials of any shape or size at a time. Thermocouples can sense ambient temperature of the autoclave and feed the temperature readings back to the controller.

At element 604, the controller can select a leading thermocouple from the one or more thermocouples to provide a representative ambient temperature of the autoclave during the composite curing process. The leading thermocouple is selected to provide an accurate representation of the ambient temperature within the autoclave. According to an embodiment, the leading thermocouple can be selected according to a business rule.

At element 606, the controller can utilize the temperature reading from the leading thermocouple in a control loop for the composite curing process (e.g., a PID loop). At 608, the controller determines that readings from the leading thermocouple are inaccurate and/or that the leading thermocouple has been rendered unusable. For example, the controller can employ a statistical analysis and determine that the readings from the leading thermocouple are inaccurate. At element 610, the controller can employ an autonomous control algorithm to automatically reconfigure the system when the leading thermocouple is rendered unusable by selecting a new leading thermocouple and eliminating the previous leading thermocouple from any further calculation.

In view of exemplary systems shown and described above, methodologies that may be implemented in accordance with the disclosed subject matter, will be better appreciated with reference to various flow charts. While, for purposes of simplicity of explanation, methodologies are shown and described as a series of blocks, it is to be understood and appreciated that the various embodiments described herein are not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g. device, system, process, component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

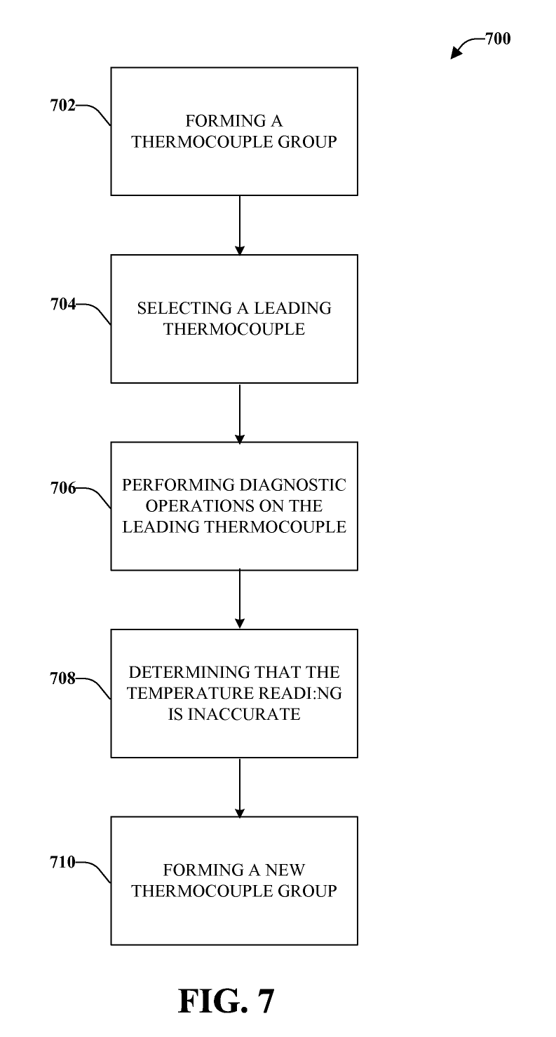

FIG. 7 is a process flow diagram 700 for an aspect of an algorithm for automated validation of health of a leading thermocouple in a composite curing process. At element 702, two or more neighboring thermocouples on a composite material within an autoclave can be grouped into a thermocouple group. Neighboring thermocouples can be determined, for example, based at least in part on curing geometry. According to an aspect, the neighboring thermocouples can be further determined based in part on composite material and/or thermocouple density. At element 704, one of the thermocouple groups is chosen as a leading thermocouple. For example, the leading thermocouple can be selected according to a business rule.

At element 706, diagnostic operations are performed on the leading thermocouple. According to an embodiment, the leading thermocouple can be encapsulated within a thermocouple wrapper, which can encapsulate thermocouple rules to allow for validation of temperature readings from the leading thermocouple. For example, a thermocouple rule can be that the temperature readings from the leading thermocouple and neighboring thermocouples should be uniform within a predefined tolerance level. Based on the thermocouple rules, the thermocouple wrapper can carry out diagnostics operations to locally determine the health of the leading thermocouple based upon communication with other thermocouples in the group. For example, the thermocouple wrapper can exchange health information about the leading thermocouple and the neighboring thermocouples and determine whether the leading thermocouple is still operational (e.g., according to the thermocouple rule). According to an embodiment, the thermocouple rule can establish that the temperature readings from the leading thermocouple and the neighboring thermocouples should be uniform; if the temperature reading from the leading thermocouple does not fall within a uniform distribution with the neighboring thermocouples within a threshold (e.g., three sigma), the thermocouple wrapper can determine that the leading thermocouple is no longer operational.

At element 708, the thermocouple wrapper can determine that the leading thermocouple is no longer operational. Upon making the determination, readings can be taken from the leading thermocouple more frequently to ensure that the temperature reading was not erroneous. At 710, if the thermocouple wrapper determines that the leading thermocouple is not operational, a new leading thermocouple can be selected. A new group of neighboring thermocouples is also selected with the previous leading thermocouple deactivated so that it is not considered in any further calculations. The process can then repeat.

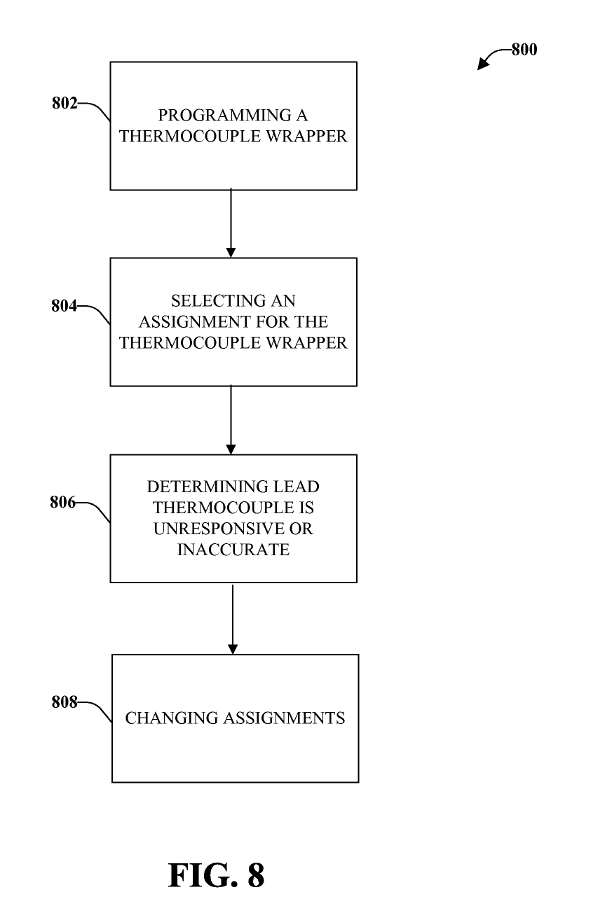

FIG. 8 is a process flow diagram 800 for an aspect of an algorithm for automated configuration of a thermocouple wrapper for a composite curing process. At element 802, a thermocouple wrapper is programmed with two assignments: thermocouple is a lead or thermocouple is a next lead. At element 804, the assignment of the thermocouple wrapper is chosen based on one or more business rules for the curing control process. For example, the business rule can define an initial leading thermocouple for the control process. A thermocouple wrapper associated with the initial leading thermocouple can be assigned as the lead. A second thermocouple wrapper associated with another thermocouple can be assigned as the next lead.

At element 806, it is determined that the leading thermocouple is inaccurate and/or unresponsive. At element 808, the assignment in the thermocouple wrapper associated with the leading thermocouple can be changed to remove the leading thermocouple from any further calculations. The assignment of the second thermocouple wrapper can change from next thermocouple to lead as the associated thermocouple becomes the lead thermocouple. Additionally, the assignment of another thermocouple wrapper associated with another thermocouple can be changed to next lead.

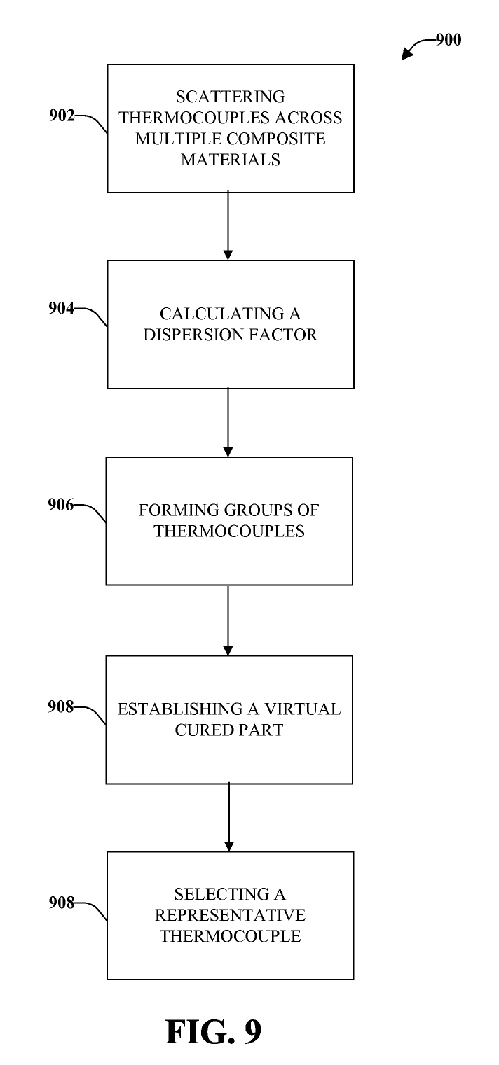

FIG. 9 is a process flow diagram of an aspect of an algorithm for automated configuration of a composite curing process. At element 902, thermocouples are scattered across multiple composite materials being cured within an autoclave. At element 904, a dispersion factor is calculated with respect to the temperature readings from the thermocouples due at least in part to the physical separation between the multiple pieces. At element 906, groups of thermocouples can be formed from several thermocouples. Each group of thermocouples can have a leading thermocouple. At element 908, the leading thermocouples can talk to each other in order to establish a virtual representation of the composite parts to establish a virtual cured part that serves as a guide for extrapolating a temperature trend. At 910, based upon the virtual cured part, a representative thermocouple for the entire process can be selected. If the representative thermocouple becomes unresponsive and/or inaccurate, the process can repeat.

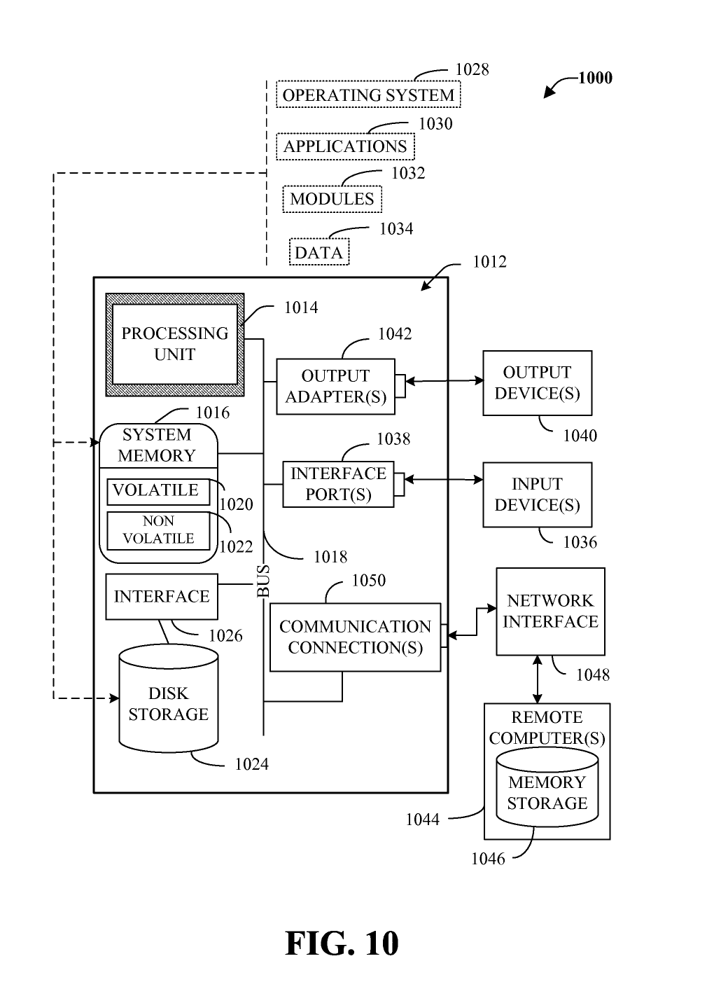

Referring now to FIG. 10, illustrated is a block diagram of a computer operable to execute the disclosed system. In order to provide additional context for various aspects thereof, FIG. 10 and the following discussion are intended to provide a brief, general description of a suitable computing environment 1000 in which the various aspects of the embodiment(s) can be implemented. While the description above is in the general context of computer-executable instructions that may run on one or more computers, those skilled in the art will recognize that the various embodiments can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the various embodiments may also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium. Communications media typically embody computer-readable instructions, data structures, program modules or other structured or unstructured data. By way of example, and not limitation, communication media include wired media and wireless media.

With reference again to FIG. 10, the illustrative environment 1000 for implementing various aspects includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1094 interface technologies. Other external drive connection technologies are within contemplation of the various embodiments described herein.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is to be appreciated that the various embodiments can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1094 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are illustrative and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet without wires. Wi-Fi is a wireless technology similar to that used in a cellular phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

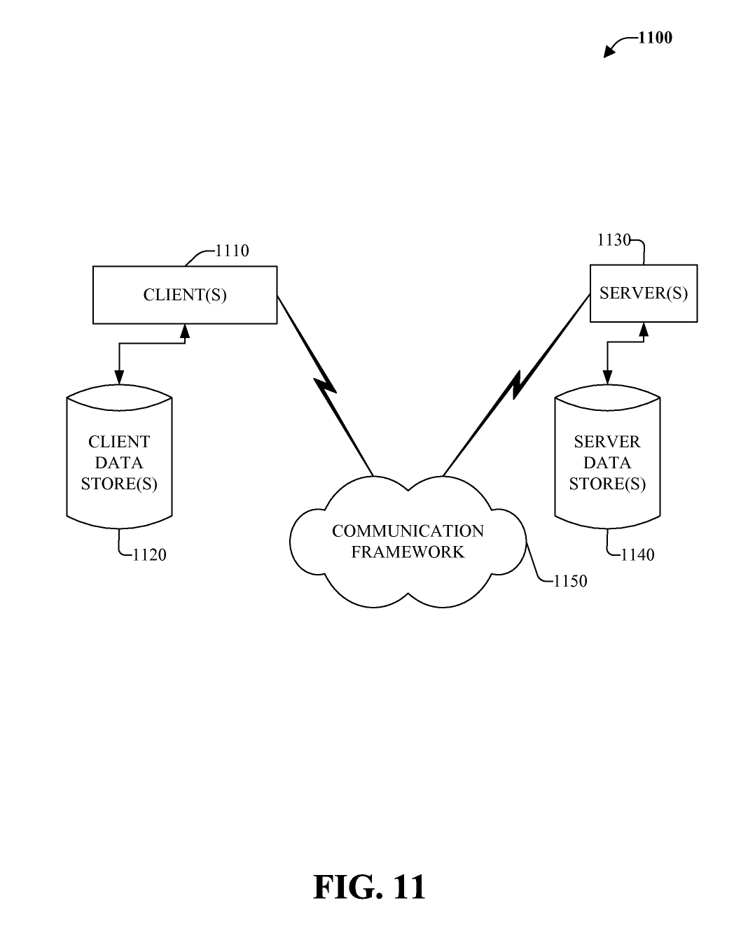

Referring now to FIG. 11, illustrated is a schematic block diagram of an illustrative computing environment 1100 for processing the disclosed architecture in accordance with another aspect. The system 1100 includes one or more client(s) 1102. The client(s) 1102 can be hardware and/or software (e.g., threads, processes, computing devices). The client(s) 1102 can house cookie(s) and/or associated contextual information in connection with the various embodiments, for example.

The system 1100 also includes one or more server(s) 1104. The server(s) 1104 can also be hardware and/or software (e.g., threads, processes, computing devices). The servers 1104 can house threads to perform transformations in connection with the various embodiments, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

It is noted that as used in this application, terms such as “component,” “module,” “system,” and the like are intended to refer to a computer-related, electro-mechanical entity or both, either hardware, a combination of hardware and software, software, or software in execution as applied to an automation system for industrial control. For example, a component may be, but is not limited to being, a process running on a processor, a processor, an object, an executable, a thread of execution, a program and a computer. By way of illustration, both an application running on a server and the server can be components. One or more components may reside within a process or thread of execution and a component may be localized on one computer or distributed between two or more computers, apparatuses, or modules communicating therewith.

The subject matter as described above includes various exemplary aspects. However, it should be appreciated that it is not possible to describe every conceivable component or methodology for purposes of describing these aspects. One of ordinary skill in the art may recognize that further combinations or permutations may be possible. Various methodologies or architectures may be employed to implement the various embodiments, modifications, variations, or equivalents thereof. Accordingly, all such implementations of the aspects described herein are intended to embrace the scope and spirit of subject claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
associating at least one thermocouple wrapper with at least one thermocouple;
determining that the at least one thermocouple is a leading thermocouple based at least in part on at least one business rule;
assigning the at least one thermocouple wrapper as a lead; and
validating a temperature reading of the at least one thermocouple according to a thermocouple rule encapsulated within the thermocouple wrapper.

2. The method of claim 1, further comprising grouping the thermocouple with at least one neighboring thermocouple.

3. The method of claim 2, further comprising communicating between the at least one thermocouple wrapper and the at least one neighboring thermocouple.

4. The method of claim 3, wherein the validating further comprises validating the temperature reading based at least in part on communicating between the at least one thermocouple wrapper with the at least one business rule.

5. The method of claim 4, wherein the validating further comprises validating the temperature reading of the at least one thermocouple according to a statistical rule and the communicating between the at least one thermocouple wrapper and the at least one neighboring thermocouple.

6. The method of claim 1, wherein the validating further comprises validating the temperature reading falls within a uniform distribution.

7. The method of claim 6, wherein the validating further comprises validating that the temperature reading falls within a three sigma uniform distribution threshold.

8. The method of claim 1, further comprising creating a plurality of groups of thermocouples across multiple composite parts in an autoclave, wherein each of the plurality of groups of thermocouples comprises a leading thermocouple.

9. The method of claim 8, further comprising communicating between the leading thermocouples and determining a virtual cured part that serves as a guide for extrapolating a temperature trend.

10. The method of claim 8, further comprising determining a representative thermocouple for the virtual cured part,

11. An industrial controller, comprising:
a memory configured to store at least one thermocouple wrapper that encapsulates at least one thermocouple and at least one thermocouple rule;
an interface configured to receive at least one business rule for setting a leading thermocouple;
a processor configured to set the at least one thermocouple as the leading thermocouple based at least in part on the business rule and execute the at least one thermocouple wrapper to validate readings from the at least one thermocouple according to the at least one thermocouple rule.

12. The industrial controller of claim 11, wherein the at least one thermocouple rule establishes that the readings from the at least one thermocouple should be in a uniform distribution with readings from a plurality of neighboring thermocouples.

13. The industrial controller of claim 12, wherein the thermocouple rule establishes that the readings from the at least one thermocouple should be within a three sigma threshold of the uniform distribution.

14. The industrial controller of claim 12, wherein the processor is further configured to set an assignment of the at least one thermocouple wrapper as lead.

15. The industrial controller of claim 12, wherein the processor is further configured to replace the at least one thermocouple as the leading thermocouple if the readings indicate the at least one thermocouple is at least one of unresponsive or inaccurate.

16. An apparatus, comprising:
a memory configured to store at least one thermocouple wrapper that encapsulates at least one thermocouple and at least one thermocouple rule;
an interface configured to receive at least one business rule for setting a leading thermocouple;
a processor configured to set the at least one thermocouple as the leading thermocouple based at least in part on the business rule and execute the at least one thermocouple wrapper to validate readings from the at least one thermocouple according to the at least one thermocouple rule.

17. The apparatus of claim 16, wherein the at least one thermocouple rule establishes that the readings from the at least one thermocouple should be in a uniform distribution with readings from a plurality of neighboring thermocouples.

18. The apparatus of claim 16, wherein the thermocouple rule establishes that the readings from the at least one thermocouple should be within a three sigma threshold of the uniform distribution.

19. The apparatus of claim 16, wherein the processor is further configured to set an assignment of the at least one thermocouple wrapper as lead.

20. The apparatus of claim 16, wherein the processor is further configured to replace the at least one thermocouple as the leading thermocouple if the readings indicate the at least one thermocouple is at least one of unresponsive or inaccurate.
